(19) United States
(12) Patent Application Publication
(10) Pub. No.: US 2003/0014368 A1
(43) Pub. Date: Jan. 16, 2003

(54) Systems, methods and apparatus for secure printing of negotiable instruments

(75) Inventors: Richard Leurig, Brentwood, TN (US); Michael Olson, Bloomington, MN (US); Dave Moos, Crystal, MN (US); Julie Vandelac, West St. Paul, MN (US)

Correspondence Address: SNELL & WILMER, ONE ARIZONA CENTER, 400 EAST VAN BUREN, PHOENIX, AZ, 850040001

(73) Assignee: Travelers Express Inc., Minneapolis, MN

(21) Appl. No.: 10/192,074

(22) Filed: Jul. 9, 2002

Related U.S. Application Data
(60) Provisional application No. 60/304,012, filed on Jul. 9, 2001.

(51) Int. Cl. G06F 17/60

(52) U.S. Cl. 705/64

(57) ABSTRACT

A secure system for requesting, approving, and printing negotiable instruments operates in a web-enabled browser-based environment. Users at a remote location connect to a central server using a conventional browser on a client computer via the Internet or another network. The user provides a digital credential such as a userid/password pair for authentication. If the user is approved, a secure connection between the server and the client computer is established. The secure connection may then be used to transfer print requests from the client to the server, or to transfer approved print jobs from the server to the client using data encryption and/or compression to secure the file. Before the negotiable instruments are printed, the server obtains identifying information from the printer and verifies that the user is authorized to use the particular printer. If the user is authorized, the negotiable instrument is printed on the printer. Various embodiments further provide reporting of negotiable instruments, as well as the ability to track or cancel instruments that have been previously issued/printed.

This application claims priority of U.S. Provisional Patent Application Serial No. 60/304,012 filed Jul. 9, 2001, which is incorporated herein by reference.

### FIELD OF INVENTION

The present invention relates generally to secure systems, methods and devices for printing negotiable instruments such as checks and/or money orders.

### BACKGROUND OF THE INVENTION

Checks, money orders and other negotiable instruments remain a popular medium for transferring funds between individuals and/or businesses. Such negotiable instruments are typically printed on paper that can be readily passed from a payor to a payee to complete a transaction. Frequently, however, the person or business delivering the instrument to a payor is not the same person or business that approves the transaction. Both bank and non-bank entities, for example, often have “branch offices” in various remote sites throughout a city, state, region, and the world. Gathering the necessary approvals for the creation and printing of checks can be cumbersome when the check request originates at a different location than the approval.

Moreover, many times a check request originates from a different site than An administrator of a franchised business, for example, may wish to approve transactions carried out by a branch office. Similarly, businesses that sell negotiable instruments (such as money orders) may wish to approve an instrument at a central location even though the instrument is later printed at a remote location closer to the purchaser. Further, with the increasing popularity of digital networks such as the Internet, the opportunities for customers to remotely print negotiable instruments (e.g. at a customer's home or office computer) correspondingly increase.

A need therefore exists for a remote printing system that allows an administrator at a central location to approve checks that are subsequently printed at remote locations. If an unauthorized user were to gain access to such a system, however, the security of the transaction would be compromised and the opportunity for fraud and theft would be significant. Because of these security concerns, conventional remote printing systems have not been widely implemented. Accordingly, there is a need for a system and method for printing negotiable instruments that enables remote creation, approval and printing while still maintaining a highly secure environment. In particular, there is a need for a secure system and method to obtain document requests, approvals, and printing via a worldwide communication source such as the Internet.

### SUMMARY OF THE INVENTION

Various embodiments of the present invention provide systems, methods and devices for securely printing negotiable instruments such as checks, money orders and other documents. One exemplary printing system provides a secure web browser-based environment for requesting, approving, and printing negotiable instruments. Users at a remote location connect to a central server using a conventional Internet browser on a client computer via the Internet or another network. The user then provides a digital credential such as a userid/password pair for authentication. If the user is approved, a secure connection between the server and the client computer is established. The secure connection may then be used to transfer print requests from the client to the server, or to transfer approved print jobs from the server to the client using data encryption and/or compression to secure the file. Before the negotiable instruments are printed, the server suitably obtains identifying information from the printer and verifies that the user is authorized to use the particular printer. If the user is authorized, the negotiable instrument is printed on the printer. Various embodiments further provide reporting of negotiable instruments, as well as the ability to track or cancel instruments that have been previously issued/printed.

These and other aspects of the invention shall become more apparent when read in conjunction with the accompanying drawing figures and the attached detailed description of exemplary embodiments.

### BRIEF DESCRIPTION OF THE DRAWINGS

The features and advantages of the present invention are hereinafter described in the following detailed description of exemplary embodiments to be read in conjunction with the accompanying drawing figures, wherein like reference numerals are used to identify the same or similar parts in the similar views, and:

FIG. 1 is a block diagram of an exemplary system for remotely printing negotiable instruments and other documents;

FIG. 2 is a block diagram of an exemplary system showing the various components of the client and server computer systems used to remotely printing documents;

FIG. 3 is an entity relationship diagram showing an exemplary process for approving and printing a documents;

FIG. 4 is a flowchart of an exemplary process for printing documents; and

FIGS. 5A-D are screen displays of exemplary user interfaces for a client system used in a remote printing system.

### DETAILED DESCRIPTION OF EXEMPLARY EMBODIMENTS

According to various exemplary embodiments, the security of a remote printing system is maintained through the use of digital credentials and/or cryptography. Data transmitted across an un-secure network such as the Internet is protected by ensuring the identity of the data recipient and by protecting the connection between sender and recipient from unauthorized monitoring. Further, users may be associated with particular terminals and/or printers for which they are authorized to print secure documents. System security is thereby improved though the use of multiple secure mechanisms such as cryptography and digital credentials acting in concert with each other.

Overview

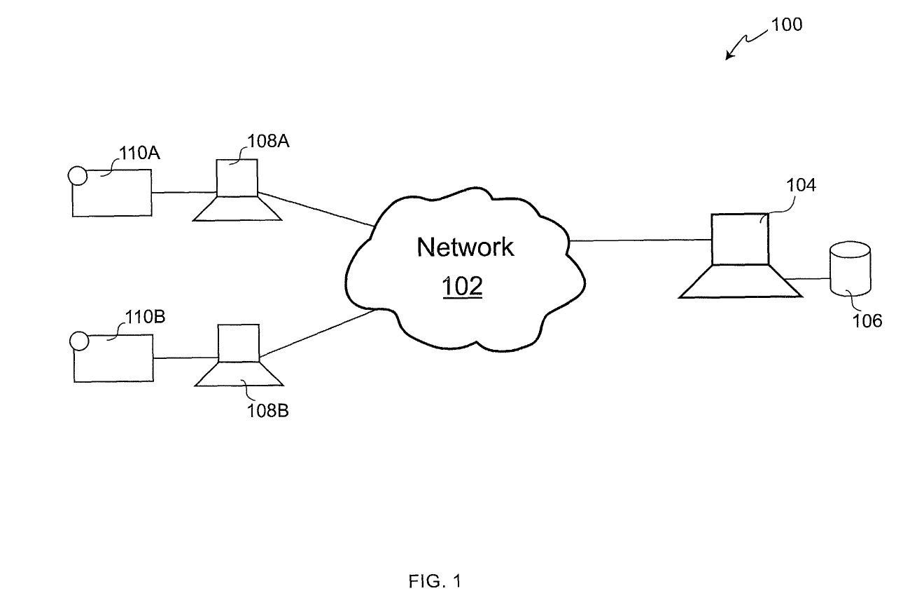

FIG. 1 is a block diagram of an exemplary system for remotely printing negotiable instruments and other documents. With reference to FIG. 1, an exemplary remote printing system 100 suitably includes a server 104 communicating with at least one client system 108A-B via a digital network 102. Server 104 communicates with a security database 106 that stores, identifying information about each user of system 100. The various client systems 108A-B may be coupled to local printers 110A-B as appropriate. Although each of the client systems 108A-B are shown coupled to printers 110A-B in FIG. 1, various client systems 108 may be used for data entry and other interaction with server 104 even though no printer 110 is attached to the system.

In operation, a user suitably uses a browser or other application running on client system 108 to contact server 104 via network 102. The user then provides a digital credential (such as a digital signature or userid/password pair) to server 104 to prove his/her identity. Server 104 validates the digital credential with the database 106 to verify that the user is authorized to use system 100. After authorization, server 104 allows the approved user to view only information related to that user's account. In this regard, the views, stored procedures, or other dynamically generated requests used by all web pages, objects, or services provided to the user are suitably filtered by the users' account identification, as discussed more fully below.

When the user is authenticated, a secure connection (using, for example, secure sockets layer (SSL) encryption) is created between server 104 and client system 108. The user provides print requests to server 104 via the secure connection for approval. After the print requests are approved and formatted by server 104, the completed print jobs are retrieved by client system 108 via the secure connection and printed on printer 110. The print process itself may include additional steps to verify that the user is authorized to use a particular printer, and that the data is not modified during transit. If all of the security criteria for the print process are met, the client computer receives an encrypted and/or compressed data file from server 106 that is decrypted and formatted for printing at client system 108. Client system 108 then creates a secure connection to printer 110 to print the document. A result of the print transaction may be returned to server 104 after the transaction is complete. System 100 thereby provides secure access via an open digital network 102 for approving and printing negotiable instruments and other documents at remote locations. The terms “negotiable instruments” and “payment instruments” are used synonymously herein, and refer to checks and money orders of all types as well as any other instruments now known or hereafter devised.

Transaction Components

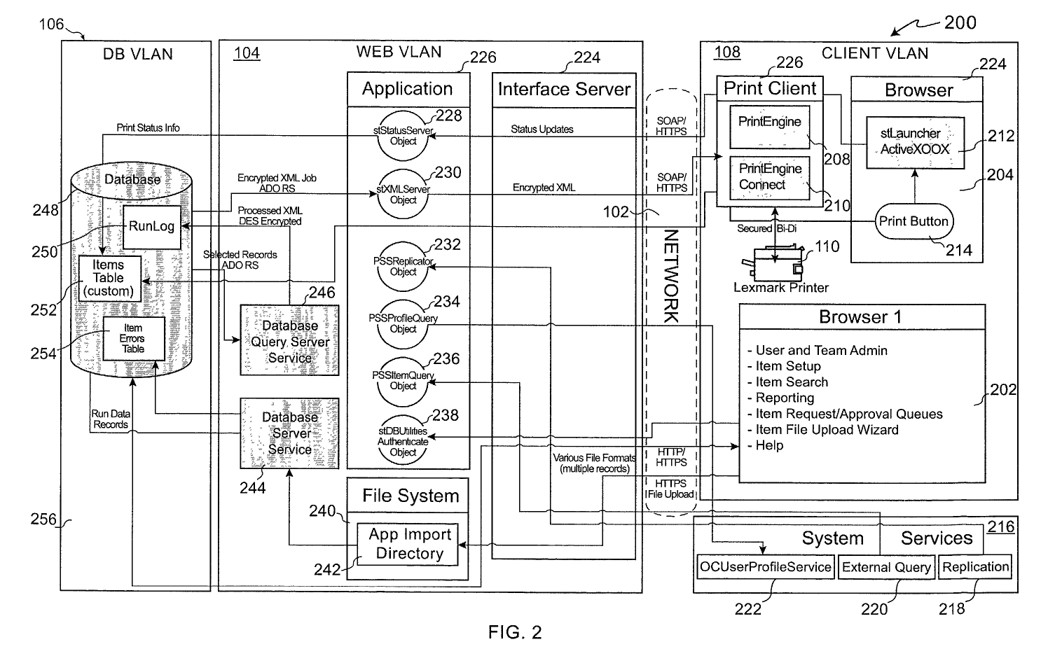

With reference now to FIG. 2, an exemplary system 200 suitably includes a server 104 interoperating with a client computer 108 as described above. Server 104 (also referred to herein as a “server system”) is any system capable of communicating via network 102 and of storing and retrieving data from database 106. Server 104 may be implemented with one or more computers, servers or other processing devices executing any operating system such as any version of the WINDOWS, UNIX, LINUX, SOLARIS, NETWARE, MacOS or other operating systems. In an exemplary embodiment, server 104 is implemented with a cluster of personal computers (PCs) running the WINDOWS operating system and communicating via TCP/IP protocols. Server 104 may also include one or more firewall systems (such as appropriately configured personal computers, routers or the like) to further enhance the security of the system by preventing unwanted access to the network. In an exemplary embodiment, an external firewall connects server 104 to network 102 to filter connections arriving via network 102. Additionally, an internal firewall may be provided between server 104 and database 106 to further restrict access to database 106 and to thereby enhance the security of data stored therein.

System database 106 is suitably designed to maintain records for multiple accounts and types of print jobs. Any type of relational, hierarchical, object-oriented or other database management system 254 may be used. A suitable database 106 may include database management software 254 using the Microsoft SQL Server 2000 product, Oracle or Sybase database products, the DB2 product available from the I.B.M. Corporation, or any other relational, hierarchical and/or object-oriented database management application. Data stored within database 106 may include print jobs that are awaiting approval (table 252), as well as print jobs that have been approved/processed (table 250). An optional error log 254 may also be provided, as well as authentication and account information about users of system 200. In an exemplary embodiment, database 106 is provided on a separate local area network 256 that is isolated from network 102 and/or from server 104 by one or more firewall systems to further enhance the security of data stored in database 106.

Network 102 is any digital network capable of facilitating communication between server 104 and client systems 108A-B. In an exemplary embodiment, network 102 is the Internet, although in other embodiments network 102 could be implemented with any public or private network such as a corporate network or extranet, a wireless network or the like. Similarly, network 102 may operate using any protocols or schemes such as TCP/IP, Open Systems Interconnect (OSI), NetWare, IP-3, Appletalk or the like.

With continued reference to FIG. 2, client computer 108 and server 104 suitably execute a number of applications, threads and processes to execute approval and print transactions. Server 104, for example, suitably includes a server interface 224 to network 102, a file system 240 that may be part of the server's operating system, and a management application 226 that implements the various server-side processes of the remote printing transaction. An optional database server service 244 and/or database query service 246 may also be provided. In an exemplary embodiment, server interface 224 is implemented with the Microsoft Internet Information Services (IIS) product that is configured to receive HTML and other connections via network 102 and to administer secure and unsecure connections between server 104 and the various client system 108. File system 240 may be an NTFS file system as commonly provided with the Windows NT and subsequent operating systems. Database query server service 246 and server service 244 may be implemented with the FormsPartner products available from Source Technologies of Charlotte, N.C. Each of the components of server 104 may, however, be implemented with other products or technologies.

Server application 226 may be implemented with any number of objects, modules, components, data structures or the like. In an exemplary embodiment, server application 226 suitably includes a status server module 228, an XML server module 230, an optional replicator module 232, an optional profile query module 234, an optional item query module 236 and an authentication module 238. Of course fewer modules or additional modules could be present in alternate embodiments of server application 226, and still other embodiments may combine the various functionalities performed by server application 226 in different ways. The terms “module”, “component” and “object” as used herein all refer to software applications, applets, routines, processes and/or the like that execute tasks within a computing system. Each of the modules in server application 226 include appropriate software code for executing one or more functions. In an exemplary embodiment, the various modules are implemented using component object module (COM) or COM+ technologies available from the Microsoft Corporation of Redmond, Wash. The modules may reside in memory on server 104 and/or in a mass storage device such as a disk drive, file server or other storage device in communication with server 104, as appropriate.

Status server module 228 suitably contains software routines to receive status queries from client computers 108 via interface server 224. Status queries may be in any format such as simple object access protocol (SOAP) and may be provided via a secure HTTPS connection established after successful authentication of a user. Upon receipt of a status query from client computer 108, status server module 228 suitably posits a query in an appropriate format (such as the structured query language (SQL) or any other format) to obtain information from database 106. Status information may relate to the status of a particular print job (e.g. “approved”, “not approved”, “printed”, “print failed”, etc.). Upon receipt of status information from database 106, status server module 228 provides an appropriate reply to client system 108 via the secure HTTPS connection.

XML server object 230 is any module capable of facilitating data transfer in any format between database 106 and client computer 108. In an exemplary embodiment, XML server object 230 suitably includes software routines for retrieving approved print jobs from database 106 and for providing the jobs to client computer 108 using interface 224. XML server object 230 is not limited to processing XML files; print jobs may be provided to client 108 in any format such as extensible markup language (XML), POSTSCRIPT, and/or the like. The formatted print jobs may be further encrypted (for example with DES or another symmetric encryption technique) to further protect the security of the data during transfer to client 108.

In the embodiment shown in FIG. 2, print jobs are appropriately formatted by database query server service 246 as described more fully below. In an alternate embodiment, however, formatting may be built into XML server object 230. Formatting tasks may include translating the print data into an XML or other format, encrypting the formatted file, and/or compressing the file. Formatted files may be provided to client 108 via the secure HTTPS connection as appropriate.

In various embodiments, system 200 interfaces with existing data processing systems such as accounting systems, customer databases, backend transaction processing systems and/or the like. Optional replicator module 232, profile query module 234 and item query module 236 provide interfaces to external system services 216, which may include a transaction monitoring system or other backend processing system. Replicator module 232, for example, provides data (such as customer data or the like) that is replicated from an external data source or other replication service 218. Profile query module 234 and item query module 236 suitably provide access to database 106 from external system services 222 and 220, respectively. Typically, services or external users requesting access to database 106 or other resources in server 104 are required to authenticate with a digital credential prior to receiving access to system 200. Backend processing systems may provide mechanisms for voiding, stopping payment, tracking, deleting, reprinting, replacing, viewing or otherwise processing negotiable instruments that have been printed using system 200.

Authentication module 238 suitably includes software routines for accepting digital credentials from system users via interface server 224 and for validating, verifying and approving access to other system resources based upon the digital credentials. In an exemplary embodiment, authentication module 238 receives digital credential data from an appropriate user at a client computer 108, verifies the credential with database 106 (or another database), and grants or denies access according to the results of the verification. If the user is approved, authentication module provides client computer 106 with a “cookie” or other data file with a digital code, signature, or the like. Client computer 106 then provides the cookie to server 106 during subsequent communications within the session without requiring further authentication by the user.

Client systems 108 (also referred to herein as “client computers”) may be implemented with any personal computer, workstation, terminal, kiosk, personal digital assistant (PDA), mobile phone or other computing device running any operating system. Each client system 108 typically includes a conventional browser program 202 such as the Internet Explorer browser available from the Microsoft Corporation of Redmond, Wash. or the Netscape Communicator browser available from the AOL/Time Warner corporation of Redwood City, Calif. Any number of client systems 108 may communicate with server 104 to make up secure printing system 200. Client systems 108 communicate with one or more printers 110 to print negotiable instruments as described herein. Printer 100 may include magnetic ink character recognition (MICR) functionality or other technology to aid in the identification and sorting of printed negotiable instruments.

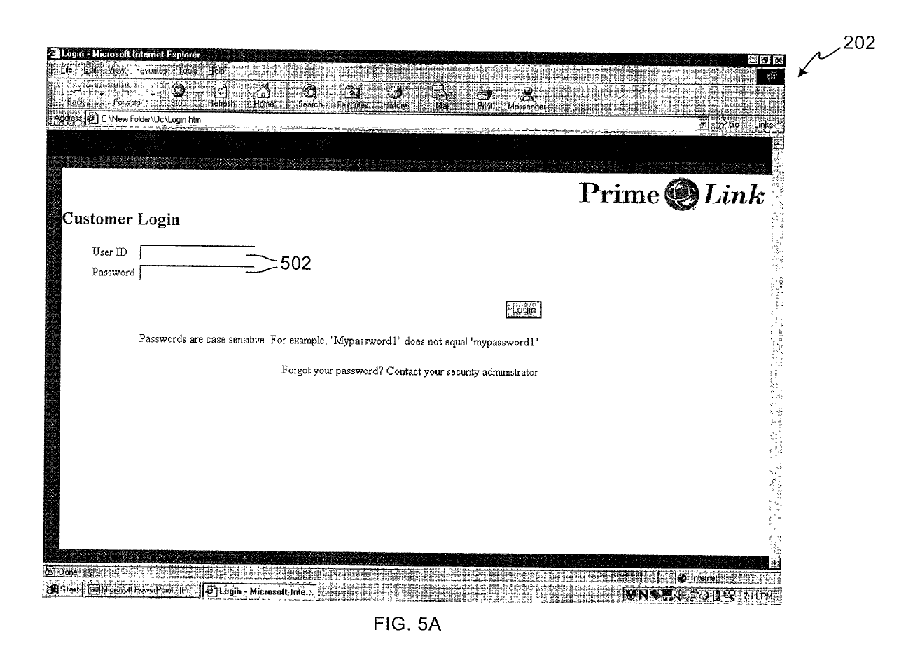

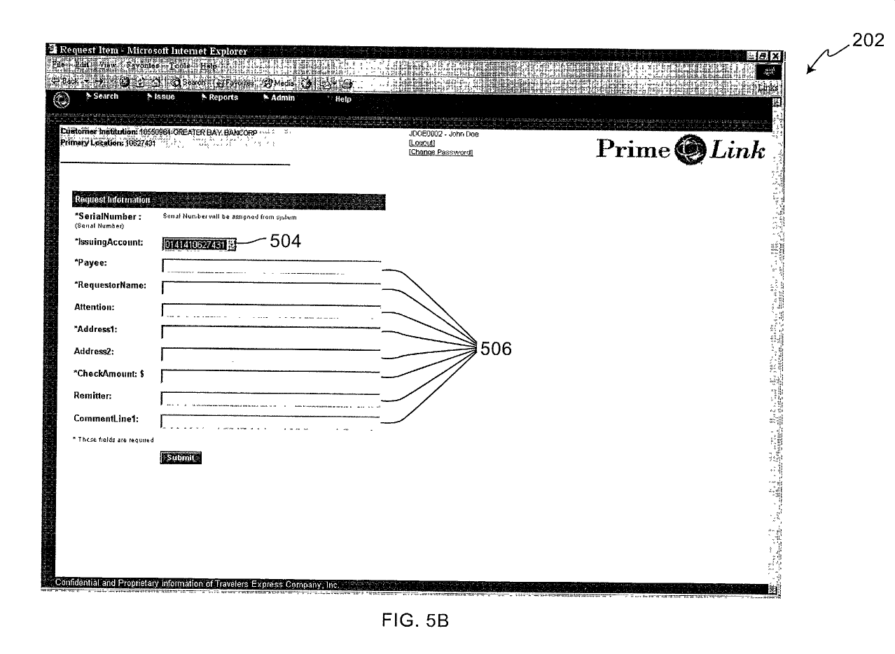

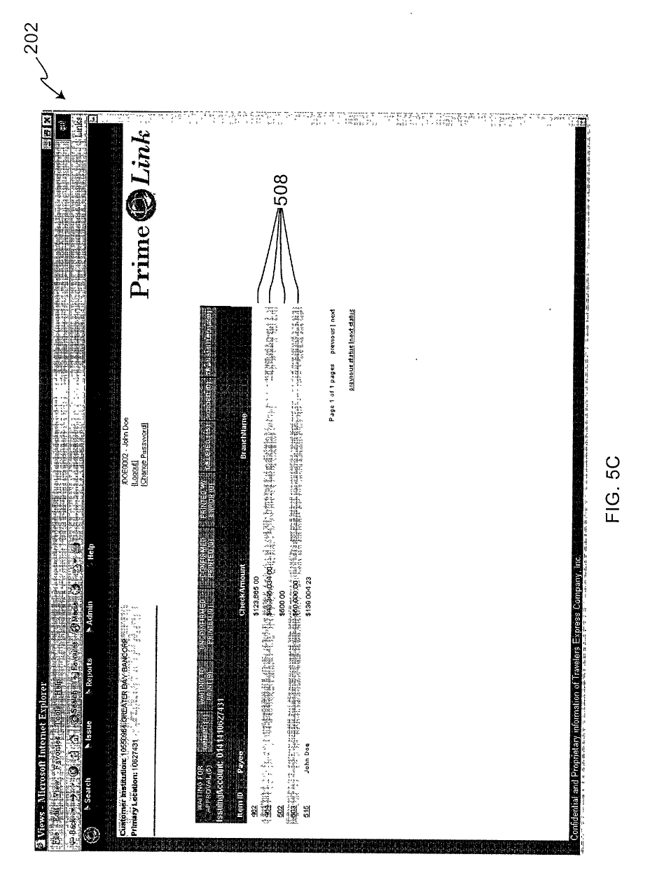

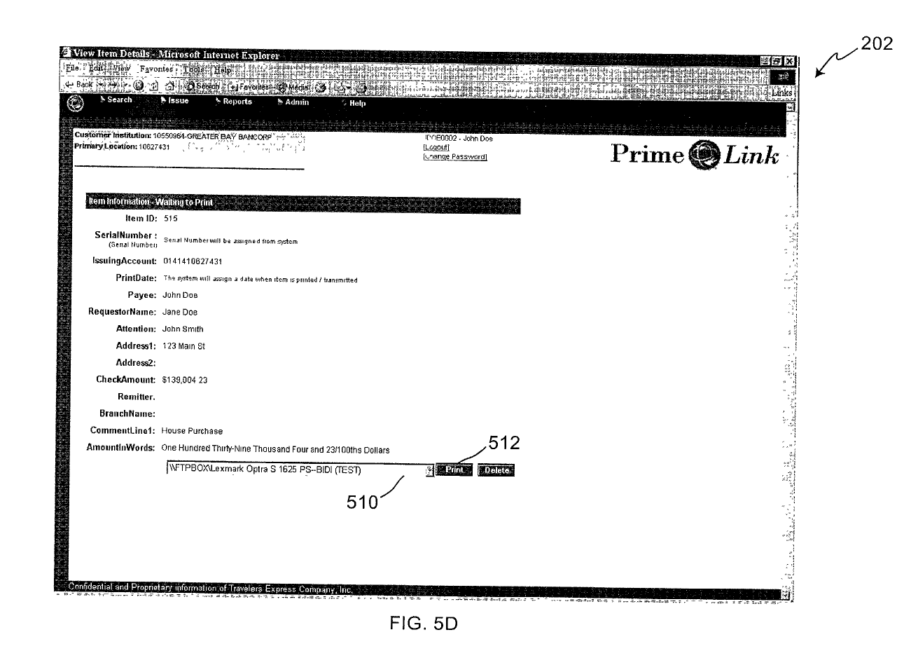

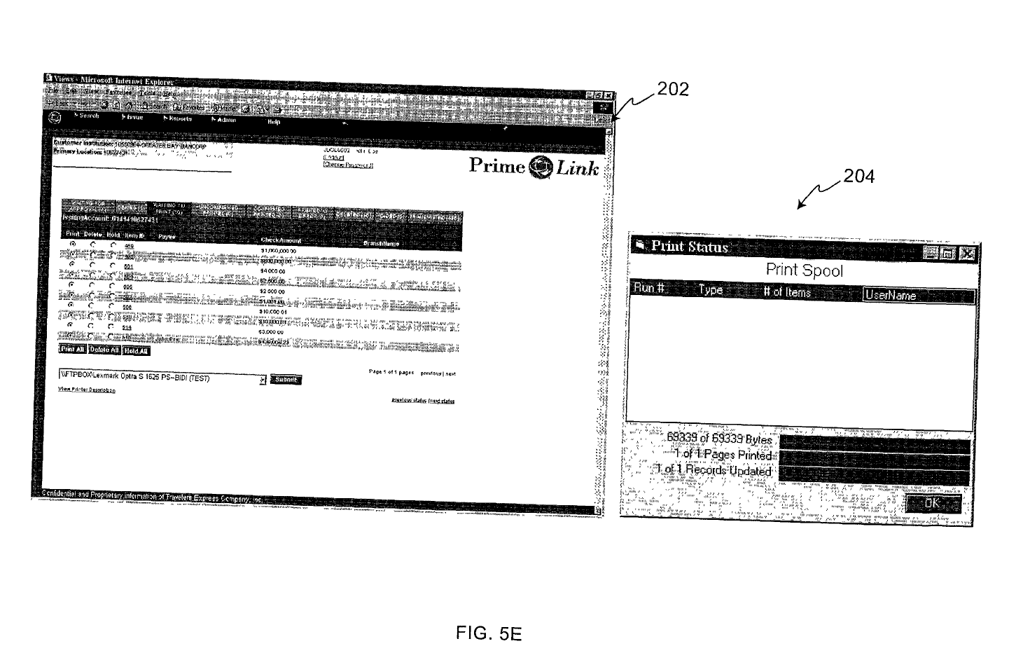

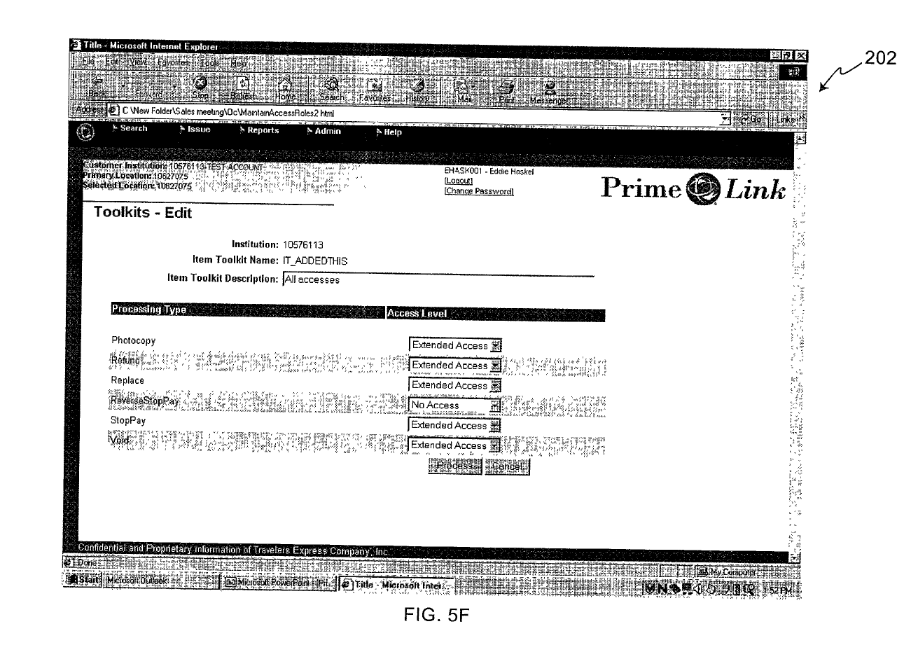

With continued reference to FIG. 2, client system 108 suitably includes one or more browser sessions 202, 204 and a print application 206 communicating with server 104 via network 102. The first browser session 202 suitably provides an interface to the user for the various functions available from server 106. Functions that may be provided include, for example, creating new print jobs, submitting new print jobs for approval, querying the status of a pre-submitted print job, generating reports, handling user and team administration functions, job setup and search functionality, and the like. First browser session 202 also provides an interface to authentication object 238 for receiving the user's digital credentials at server 104. Exemplary user displays that may be visible within browser session 202 are shown in FIG. 5 and are discussed more fully below.

During an exemplary transaction, a user at client system 108 suitably initiates browser session 202 and initiates a conventional HTTP connection with server 106 via network 102. The request for a connection is received at interface server 224, which provides an appropriate response requesting that the user provide a digital credential for authentication. After the user provides the credential, browser session 202 contacts authentication module 238 to request verification of the credential. If validation is successful, the user receives a cookie from authentication module 238 and is granted access to appropriate portions of server 106 via a secure HTTPS connection. The user may then enter transaction data or other information appropriate to request a print job. Such information may include, for example, a payor name, dollar amount, account number and/or the like.

Print job requests may be provided to server 106 via real-time data entry, batch processing, or according to any other technique. In an exemplary embodiment, print job requests are stored in a datafile on client computer 108 prior to being uploaded to server 104. Batch file uploads may take place at regular time intervals (e.g. hourly, daily, weekly, etc.) or in response to an express command from the user, or according to any other scheme. Uploads may be handled by an upload wizard, applet, ActiveX control or the like that suitably establishes a connection with interface server 224 and transfers the batch file to a directory 242 within file system 242 of server 104. Transfer may take place using, for example, the trivial file transfer protocol (TFTP), HTTPS file upload, or any other technique. Jobs stored in table 252 may be associated with metadata that describes the time the file was uploaded, the status of the file, any error messages, or the like.

In an exemplary embodiment, database server service 244 suitably retrieves files stored in directory 242 and processes them for entry into database 106. Processing includes separating the various jobs contained within the batch file into individual print job requests, formatting the requests as appropriate, and storing the requests within item table 252 of database 106. After print job requests are stored in table 252, database query server service 246 retrieves the jobs from database 106, processes the appropriate approval(s), and optionally formats the print job for printing. Approval may take place at regular intervals, as an approving administrator becomes available, or according to any other scheme. In various embodiments, certain print jobs (such as those involving relatively low monetary amounts) may be automatically approved without manual approval by a human user. Approved print jobs are placed into a suitable format (e.g. XML) for transmittal to client computer 108, and then encrypted and/or compressed as appropriate. The processed file is then stored in a log 250 within database 106 for subsequent retrieval by the end user. In alternate embodiments, database server service 244 may be omitted or otherwise modified such that data is imported from client computer 108 to database 106 in any manner.

The user is able to obtain status information about the various print jobs using a browser session 202, which formats a status query to status server module 228. If the print job has been approved, the user clicks on a print button 214 or otherwise initiates a print transaction that suitably opens a second browser session 204 to handle the print process. Browser session 204 may include a print launcher module 212, which is a script, applet, ActiveX control or other component that launches print client module 206. Print launcher module 212 and print client module 206 may be separately installed on client computer 108 by a user or administrator, or module 212 may be retrieved from server 106 through a browser session as appropriate.

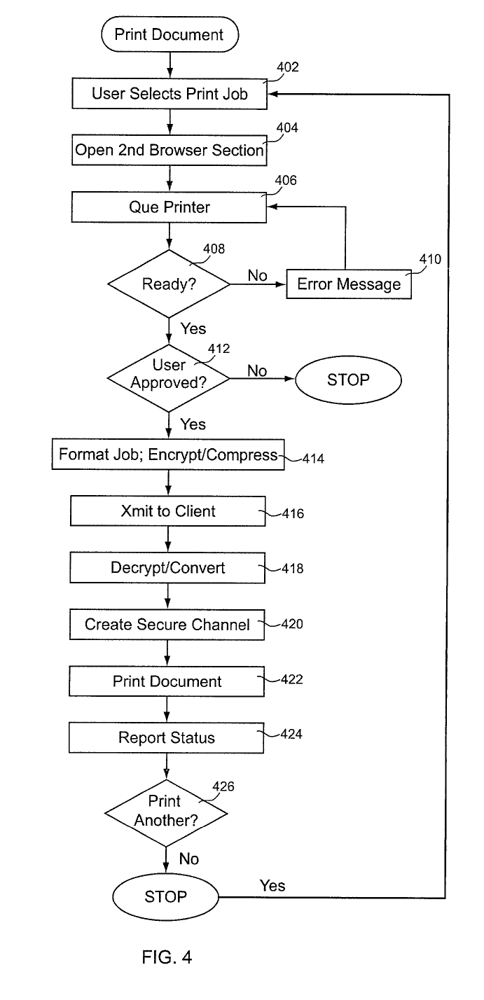

Print client 206 interacts with server 106 to print the negotiable instrument or other document on printer 110. The print process is described in detail in FIG. 4 and accompanying text. Briefly, print client 206 interacts with XML server module 230 and authentication module 238 to provide information about printer 110 and to ensure that the user is authorized to use the particular printer 110. If the user is authorized to use the printer, the formatted print job is provided to a print engine module 208 within print client module 206, which suitably decrypts the file and converts the file into an appropriate format for printing (e.g. POSTSCRIPT or the like). The formatted data file may be encrypted with DES or another encryption routine before being provided to printer 110, which then decrypts the file and prints the document. A result or status message may be provided from printer 110 to print client module 206, which then relays the status to status server object 228 for eventual storage as metadata within database 106 to complete the printing transaction.

Accordingly, a system 200 allows users at a client computer 108 to remotely authenticate with a server 104 to submit, approve and print various negotiable instruments on a printer 110. Although system 200 has been described with reference to FIG. 2 for purposes of simplicity and illustration, many alternate embodiments could be formulated. Each of the software components described above, for example, may be modified or eliminated in alternate embodiments. Moreover, the functionalities described by the various modules and components may be combined, separated or otherwise modified without departing from the scope of the invention.

Transaction Process

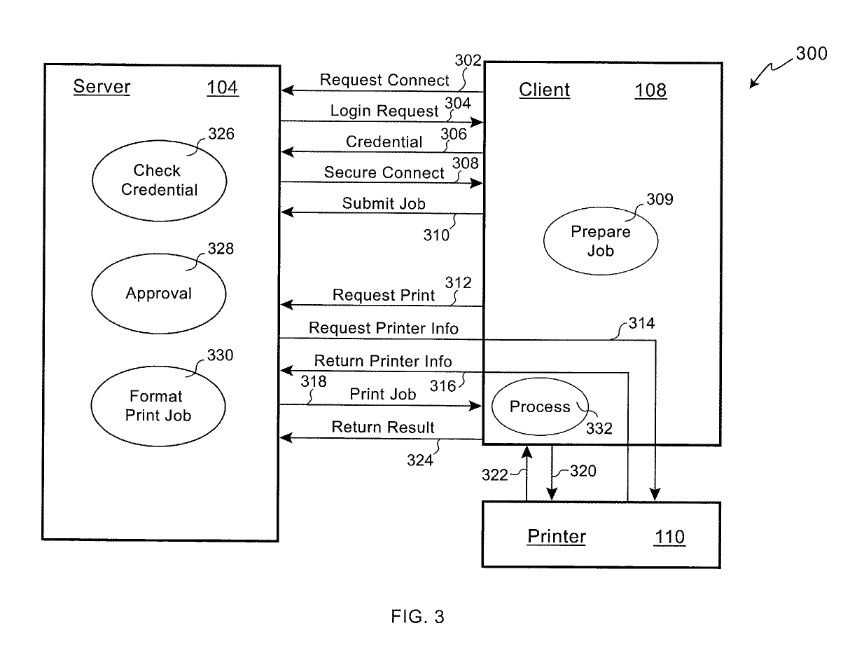

With reference now to FIG. 3, a method 300 for processing a negotiable instrument suitably begins with a user at client system 108 requesting a connection with server 106 (step 302). This request may be placed by initiating a session with a browser application and entering an appropriate uniform resource locator (URL) to direct the browser to establish a connection at an appropriate port (such as HTTP port 80) on server 106. A document or web page in an appropriate format (such as the hypertext markup language (HTML) file with a cascading style sheet (CSS) or other form-type layout) may be provided from server 106 to client system 108 to request a digital credential (step 304). The user provides the digital credential as appropriate, and submits the information to server 104 (step 306). In various embodiments, the digital credential may be implemented as a userid/password pair, digital signature or the like. Alternatively, the credential may be provided from a smartcard, token, biometric reading or other attribute physically carried by the user and read by a reader, scanner or similar device coupled to client system 108.

During login, server 106 validates the user's credentials with database 106 (FIG. 1) to authenticate the identity of the user (step 326). Users are appropriately approved if the provided digital credential corresponds to data previously stored in database 106. Additionally, the user's physical location or electronic address may be further evaluated for heightened security. That is, the user's address may be compared with an approved address in database 105 to verify that the user is accessing server 104 from an approved client computer 108. Suitable addresses for comparison include internet protocol (IP) addresses, microprocessor serial numbers, media access control (MAC) addresses, ETHERNET network addresses, or other identifiers associated with a particular client terminal or system. This feature helps to prevent even authorized system users from logging into the system from unauthorized locations.

If validation fails, the user is appropriately denied access to server 104. If there is a validation match, however, server 104 suitably creates a secure connection with client system 108 over network 102 (FIG. 1). The secure connection may be established using any type of security or cryptographic method such as secure sockets layer (SSL) encryption (also referred to herein as an “HTTPS” connection). A randomly-generated session-level datafile (i.e. “cookie”) may additionally be written to client computer 108. The “cookie” contains a digital code that verifies that authentication of the user was successful for subsequent re-authentication during the transaction session. After successful authentication, the user's login data is suitably cached in a local database on server 104 and the user is granted access to a main entry page (which may be an HTML document or other appropriate web page) or other data as appropriate. As the user continues to interact with server 106 throughout the transaction session, the session cookie and client IP address may be periodically verified against the cached information at server 104 as the user navigates through the web site. This feature permits the system to re-authenticate the user at various times during the session without requiring re-entry of the digital credential; if verification fails, access to server 104 can be denied.

After the user is authenticated with server 104, transaction requests may be entered into system database 106 (FIG. 1) by the authorized user (step 309). Using the browser-based interface as appropriate, the user enters transaction requests through manual data entry, batch file upload, or any other suitable technique. The manual data entry interface may provide a web page or other suitable form for entering individual job requests. The file upload functionality simplifies the integration of data into various other systems such as accounting and loan origination systems as appropriate. Print jobs (i.e. documents or negotiable instruments requested to be printed) are suitably uploaded into the system as batch files through an HTTP, file transfer protocol (FTP) or other appropriate interface (step 310). Server 104 suitably stores the print jobs as “print queues” in database 106 prior to approval.

After jobs are added to database 106, the jobs remain available for approval (step 328). Administrators or other users who are authorized to approve transactions suitably authenticate with server 104 and view the “request queues” from an appropriate terminal so that the records corresponding to the various print jobs can be approved. In one embodiment of the invention, administrators are restricted to view and approve jobs based upon the administrator's pre-determined authority, the document's amount, and the document's profile. The logon and authentication process for administrators/approving users typically requires presentation of a digital credential similar to the user authentication process described above.

Each document type (e.g. check, money order, etc.) may have an approval profile that is defined by an administrator. Approvals may be automatic or may require user intervention. For example, one document type may have automatic approval if the amount in question is less than $100.00. Records that are not approved automatically may be approved manually by a user with the appropriate authorization level. Multiple levels of approval may be included in the system, (i.e., a “Level Two” approval may be required for all records between $100.00 and $999.00, and a “Level Three” approval for money orders between $999.01 and a maximum, e.g., $10,000.00). In this regard, the approval logic may be based on multiple criteria such as the approving party's authority level, the document dollar amount, the document type (e.g. check vs. money order), and/or the like. Such approval logic may be implemented with conventional rules-based logic or through any other appropriate technique.

After print jobs are approved, users may request print jobs using the user interface of client system 108. According to one embodiment, an authenticated user views a short description/title of an approved job through the browser interface of client system 108. The user selects a desired print job and client computer 108 requests the appropriate print job from server 104 (step 312).

Upon receiving a print request, server 104 suitably verifies that the authenticated user is authorized to print documents on the particular printer 110 (step 314). Server 106 requests a serial number or other identifying information from printer 108 before, providing printable data to client system 108. The identifying information received from the printer (step 316) may then be compared with data in database 106 to verify that the authenticated user has permission to use the particular printer 108. If the print transaction is verified, then the system suitably merges the selected data with the appropriate form(s) and generates an appropriate data file for transmittal to client system 108 (step 330). The data file may be in any format such as extensible markup language (XML) or any other format. Server 104 suitably encrypts and/or compresses the data file prior to transmittal to client 108. Encryption may be conducted using the data encryption standard (DES) or any other symmetric algorithm. Alternatively, the data may be encrypted with a public key corresponding to client computer 108 such that client computer 108 is allowed to de-crypt the data file using a private key in accordance with conventional asymmetric cryptography techniques. In yet another embodiment, the data file is transmitted to client system 108 via a secure channel protected with SSL and/or other cryptography.

After the data file is prepared at server 104, the file is securely downloaded to client 108 (step 318) for further processing. Client computer 108 suitably decrypts and/or decompresses the data file, as appropriate, and converts the data file into a format that is appropriate for printing such as POSTSCRIPT format or another format that is understood by printer 110 (step 332). Client computer 108 may further encrypt and/or compress the resultant printable file with DES or another encryption routine prior to transmittal to printer 110.

After the processing at client computer 108 is complete, the converted data file is provided to printer 110 (step 320) so that the negotiable instrument or other document can be printed. The converted data file may be encrypted with DES encryption or otherwise protected by client computer 108 prior to transfer to printer 110. In an exemplary embodiment, client computer 108 communicates with printer 110 via a secure connection that is encrypted by DES, SSL or other cryptographic techniques. After printing is complete, printer 110 provides a status response (step 322) to client system 108, which in turn provides a status report to server 104 (step 324) to complete the transaction. Status information for each transmitted page may include, e.g., a status of “submitted”, “denied”, “approved-waiting to print”, “hold”, “printed”, “printed with error”, “deleted”, “transmitted”, “manually processed” and the like.

Additional security mechanisms may be present in certain embodiments. In some embodiments, for example, re-authentication using the cookie stored on client computer 108 occurs each time a user selects a job to print. In a particularly secure embodiment, every print request received by a user is independently validated by server 104 prior to printing. In such embodiments, system 200 may further include “inactivity timeouts” for each user such that the user may be required to re-authenticate using the login process outlined above if a pre-defined period of inactivity is identified. Still further, server 104 may maintain daily printing limits to restrict the number of documents or the total value amount printed by a particular user during a particular time period (e.g. daily, weekly, monthly, etc.). Logging and/or reporting functions may also be provided to enhance the security of process 300.

An Exemplary Printing Process

With reference now to FIG. 4, an exemplary printing process 400 suitably begins when the user selects a print job (step 402) from a browser session 202 (FIG. 2) established between client 108 and server 104. When the user selects a print job, a second browser instance 204 is suitably created to handle the print process (step 404). The second browser session 204 inter-operates with print client module 206 as described above in conjunction with FIG. 2. Before data is provided from server 104 to client 108, however, server 104 suitably queries the printer to obtain additional information (step 406). To query the printer, server 104 suitably formats the query in an appropriate format (e.g. as a printer job language (PJL) query). The query is delivered to the printer via second browser session 204 (step 406), which forwards the query to printer 110 using any appropriate interface, such as the Winsock dynamically linked library (DLL) that is typically provided with the Windows operating system. The Winsock DLL contains programming commands that allow server 104 to communicate with printer 110 in PJL or another protocol to obtain status and identifying information. In an exemplary embodiment, server 104 requests and obtains information about the printer's make and model, serial number and operating status (e.g. turned on, ready to print, etc.). The response from printer 110 is transferred to server 104 via a secure connection established with browser session 204. If the printer is not ready to print (step 408), an error message is displayed to the user (step 410), who may then correct the problem by turning on the printer, checking network connections, or taking other remedial actions. Server 104 then queries printer 110 a second time to verify that the printer is operational.

Server 106 suitably uses identifying information (e.g. serial number, NIC address, etc.) obtained from the query to approve the user's access to the particular printer. Each system user may be enabled or disabled from using certain printers by adjusting that user's account information in database 106. Additionally, users may be assigned to workgroups within database 106 such that the access or printing privileges of all workgroup members are simultaneously modified. Accordingly, server 106 suitably cross-references the printer identification with the users' database entry to verify that the user (or the user's workgroup) is authorized to use the printer (step 412). If the user is not approved, the print process is terminated.

If the user is approved, however, the print process continues by preparing the print job at server 104 (step 414). Processing of the print job need not take place in response to successful authorization of the user; to the contrary, print jobs may be processed as approved, or at any other appropriate time. Processing step 414 suitably includes converting the print job from a raw format to an XML or other appropriate data file format that can be understood by client computer 108. The converted file, which contains information about the document to be printed, is then encrypted (using DES or other encryption) and compressed (using LZW or another appropriate compression technique). The processed file is then transported to client 108 via the secure connection (step 416).

Client computer 108 suitably receives the encrypted data file at the second browser session 204, which provides the file to a print engine module 208 associated with second browser session 204. Print engine module 208 decrypts the data file to extract information about the document to be printed (step 418). Print engine module 208 further converts the data file to a format that can be understood by printer 110, such as POSTSCRIPT or another format.

Printer connect module 210 then creates a secure channel between client computer 108 and printer 110 (step 420). Printer 110 may be connected to client computer 108 via a local area network (LAN) or other network, or may be coupled via a direct serial, parallel, USB or other connection. In an exemplary embodiment, the secure connection between client computer 108 and printer 100 is a DES-encrypted data channel, although SSL or other cryptographic techniques could also be used. The formatted data file is then provided to printer 110 through the secure channel so that the negotiable instrument or other document may be printed (step 422). In some embodiments, a password or other code used to activate MICR functionality in printer 110 is provided by client computer 108. MICR passcodes may be maintained within print engine module 208, within database 106, or elsewhere within system 200. Status updates may be provided from printer 110 to server 104 via client computer 108, as appropriate (step 424), and the user may be prompted to print another transaction (step 426). Alternatively, process 400 may terminate when the negotiable instrument is printed.

While an exemplary printing process 400 has been described with reference to FIG. 4, the invention is not so limited. Each of the steps describe in process 400 may be combined, separated or otherwise modified without departing from the scope of the invention.

Exemplary User Interfaces

FIGS. 5A-F are diagrams of exemplary user interfaces suitable for display to users of system 200. The exemplary interfaces shown in each of the drawings are for purposes of illustration only, and it will be appreciated that the interfaces used in an actual embodiment may be modified significantly. For example, the various screen components, data fields, menus and the like may be rearranged, deleted or otherwise modified in various alternate embodiments.

FIG. 5A is an exemplary user interface for receiving digital credentials such as userid/password information from the user. Credentials entered into data fields 502 may be provided by browser session 202 to authentication module 238 of server 104 to identify the user and to create the secure connection described above.

FIG. 5B is an exemplary interface for entering data about a negotiable instrument. After the user is authenticated with server 104, the user is optionally allowed to select an account 504 from which to draw funds, and to enter data about the negotiable instrument into data enter fields 506. Information entered into fields 506 is suitably assembled into a data packet using, for example, cascading style sheets or other functionality within browser 202. The assembled data is then provided to import directory 242 or another appropriate portion of server 104 via the secure HTTPS connection.

FIG. 5C is an exemplary interface for an administrator to view print jobs 508 awaiting approval. The administrator suitably selects one or more print jobs 508 to view additional information about the job and/or to approve the job 508 for printing by a remote user.

FIG. 5D is an exemplary interface showing additional data about an approved print job that is awaiting retrieval and printing. The user may select a desired printer 110 using data field 510, and may activate the print process by clicking on print button 512, as appropriate. In an exemplary embodiment, print button 512 corresponds to print button 214 shown in FIG. 2.

FIG. 5E is an exemplary user interface showing the first and second browser sessions 202 and 204 as discussed above in conjunction with FIG. 2. Primary browser session 202 shows data retrieved from server 104 relating to approved print jobs that are available for printing. Browser session 204 shows a print spool of items being processed by print engine module 208, as appropriate.

FIG. 5F is an exemplary interface to a “backend” system for tracking, stopping payment, or otherwise modifying the negotiable instrument after printing is complete. The backend system may be interfaced via system services 216 in FIG. 2, or through any other interface. Exemplary actions that may be performed by such a system include obtaining a digital screen image of an issued transaction instrument, obtaining a photocopy of a transaction instrument that has cleared the payment process, issuing a refund for a transaction instrument that was previously purchased, voiding or re-printing a payment instrument that was previously printed, and/or issuing a replacement for a transaction instrument that was previously printed. An example of a post-printing backend processing system is provided by Travelers Express, Inc. of Minneapolis, Minn.

Conclusion

Accordingly, a system, method and device for processing negotiable instruments and other documents is appropriately provided. The subject matter described herein is particularly suited for use in connection with printing of negotiable instruments. As a result, several exemplary embodiments of the present invention is described in that context. It should be recognized, however, that such description is not intended as a limitation on the use or applicability of the present invention, but is instead provided merely to enable a full and complete description of an exemplary embodiment. In practice, however, the systems, methods and devices disclosed herein could be used to remotely print any type of document, including tickets, licenses, certificates and/or any other type of document. Further, the various software components described herein could be stored on any digital, optical or magnetic storage medium such as a compact disk, floppy disk, digital memory, optical disk or the like.

The particular implementations shown and described herein are examples of the invention and are not intended to otherwise limit the scope of the invention in any way. The connecting lines shown in the various figures contained herein are intended to represent exemplary functional relationships and/or physical couplings between the various elements. It should be noted that many alternative or additional functional relationships, physical connections or logical connections may be present in a practical remote printing system. The corresponding structures, materials, acts and equivalents of all elements in the claims below are intended to include any structure, material or acts for performing the functions in combination with other claimed elements as specifically claimed. The scope of the invention should be determined by the appended claims and their legal equivalents, rather than by the examples given above. No item or component is essential to the practice of the invention unless the element is specifically described herein as “critical”, “essential” or “required”.

What is claimed is:

1. A system for printing a negotiable instrument over a digital network, the system comprising:
a client computer;
a server communicating with the client computer over the digital network, wherein the server is configured to receive an authorization request from the client computer, to establish a secure connection with the client computer if the authorization request is approved, to receive a subsequent request to print the document from the client computer via the secure connection, and to provide a data file describing the document to the client computer via the secure connection in response to the subsequent request; and
a printer coupled to the client computer, wherein the printer is configured to receive the data file via a second secure connection between the client computer and the printer, to decrypt the data file, and to print the transaction instrument using the data file.

2. The system of claim 1 wherein the request comprises a digital credential.

3. The system of claim 2 further comprising a database in communication with the server, and wherein the server is further operable to query the database to verify the request.

4. The system of claim 3 wherein the server is further operable to query the printer prior to providing the data file to obtain identifying information about the printer, and to correlate the identifying information with the digital credential.

5. The system of claim 4 wherein the server is further operable to correlate the identifying information and the digital credential with an entry in the database.

6. The system of claim 2 wherein the digital credential comprises a password.

7. The system of claim 2 wherein the digital credential comprises a digital signature.

8. The system of claim 1 wherein the client computer is further configured to receive the data file from the server via the secure connection, to format the data file, and to encrypt the data file in the encrypted format prior to passing the data file to the printer.

9. The system of claim 8 wherein the second secure connection comprises data encryption standard (DES) encryption.

10. The system of claim 9 wherein the secure connection comprises secure sockets layer (SSL) cryptography.

11. A method of printing a negotiable instrument, the method comprising the steps of:
providing a user credential to a server to establish a secure connection with the server;
requesting a print transaction from the server via the secure connection;
receiving a data file from the server in response to the requesting step, wherein the data file contains information about the negotiable instrument;
establishing a second secure connection with a printer; and
transmitting the data file to the printer via the second secure connection to print the negotiable instrument.

12. The method of claim 11 further comprising the step of obtaining a confirmation from the printer to verify that printing is complete.

13. The method of claim 11 further comprising the step of providing a menu to the user, the menu comprising an option to track the negotiable instrument after the negotiable instrument has been printed.

14. The method of claim 13 wherein the menu further comprises an option to stop payment of the negotiable instrument.

15. The method of claim 13 wherein the menu further comprises an option to void the negotiable instrument.

16. The method of claim 13 wherein the menu further comprises an option to process the refund for a negotiable instrument.

17. The method of claim 13 wherein the menu further comprises an option to delete the negotiable instrument.

18. The method of claim 13 wherein the menu further comprises an option to provide the photocopy of a negotiable instrument.

19. The method of claim 13 wherein the menu further comprises an option to replace the negotiable instrument.

20. The method of claim 13 wherein the menu further comprises an option to view an image of the negotiable instrument.

21. The method of claim 13 wherein the menu further comprises an option to reprint the transaction instrument.

22. The method of claim 11 wherein the step of providing a credential comprises establishing a first browser session with the server.

23. The method of claim 22 wherein the requesting step comprises opening a second browser session over the secure connection with the server.

24. The method of claim 23 wherein the requesting step further comprises the steps of:
receiving a printer status query from the server at the second browser session;
opening a printer connection from the second browser session to the printer;
receiving a printer status response from the printer via the printer connection; and
providing the printer status response to the server via the second browser session.

25. The method of claim 24 further comprising the step of unlocking a secure printing function in the printer.

26. The method of claim 11 wherein the data file comprises an extensible markup language format.

27. The method of claim 26 wherein the data file is encrypted prior to the receiving step.

28. The method of claim 27 further comprising the step of formatting the data file after the receiving step.

29. The method of claim 28 wherein the formatting step comprises decrypting the data file.

30. The method of claim 29 wherein the formatting step further comprises formatting the data file in a printer-readable format.

31. The method of claim 30 wherein the formatting step further comprises encrypting the data file prior to the step of providing the data file to the printer.

32. The method of claim 31 wherein the encrypting step comprises data encryption standard (DES) cryptography.

33. A method of processing a negotiable instrument, the method comprising the steps of:
receiving a credential from a client computer;
validating the credential to authenticate a user of the client computer;
establishing a secure connection with the client computer in response to successful validation;
receiving a request via the secure connection to print the negotiable instrument;
querying the client computer to obtain identifying information about a printer;
correlating the identifying information with the credential to confirm that the user is authorized to use the printer; and
providing an encrypted data file containing information about the negotiable instrument to the client computer in response to successful confirmation of the user.

34. An application server for processing a document over a digital network, the application server communicating via the digital network and with a database, wherein the applications server comprises:
an administrative component configured to receive a credential from a user at a client computer, to validate the credential with the database, and to establish a secure connection with the client computer in response to successful validation of the credential;
a print component responsive to a request via the secure connection to print the negotiable instrument, wherein the print module is configured to query the client computer to obtain identifying information about the printer, and to communicate with the security module to verify that the user is authorized to access the printer; and
an encryption component configured to encrypt a data file containing information about the document to the client computer in response to successful verification of the user, whereupon the encrypted data file is provided to the client computer for printing the document.

35. The application server of claim 34 wherein the application server communicates with the digital network through an external firewall.

36. The applications server of claim 35 wherein the application server further communicates with the digital network through an internal firewall.

37. The applications server of claim 34 wherein the encryption component is further operable to compress the data file.

38. A computer-readable medium having computer-executable instructions stored thereon for controlling a computer to process a negotiable instrument, wherein the instructions comprise:
a first software component configured to provide a credential received from a user to a server to establish a secure connection with the server;
a second software component configured to request authorization from the server for a print transaction via the secure connection;
a third software component configured to receive a data file associated with the negotiable instrument from the server via the secure connection in response to the request;
a fourth software component configured to establish a second secure connection with a printer; and
a fifth software component configured to transmit the data file to the printer via the second secure connection to print the negotiable instrument.

39. A computer-readable medium having computer-executable instructions stored thereon for controlling a computer to process a negotiable instrument, wherein the instructions comprise:
a first software component configured to receive a credential from a client computer;
a second software component configured to validate the credential to authenticate a user of the client computer;
a third software component configured to establish a secure connection with the client computer in response to successful validation;
a fourth software component configured to receive a request via the secure connection to print the negotiable instrument;
a fifth software component configured to query the client computer to obtain identifying information from a printer;
a sixth software component configured to correlate the identifying information with the credential to confirm that the user is authorized to use the printer; and
a seventh software component configured to provide a data file containing information about the payment information to the client computer in response to successful confirmation of the user.

40. A system for processing a document over a digital network, the system comprising:
a client computer;
a server communicating with the client computer over the digital network, wherein the server comprises:
means for receiving an authorization request from the client computer,
means for establishing a secure connection with the client computer if the authorization request is approved;
means for receiving a subsequent request to print the document from the client computer via the secure connection; and
means for providing a data file describing the document to the client computer via the secure connection in response to the subsequent request; and
a printer coupled to the client computer, wherein the printer comprises:
means for receiving the data file via a second secure connection between the client computer and the printer;
means for decrypting the data file; and
means for printing the document using the data file.

41. A method of operating a system for printing negotiable instruments over a digital network, the method comprising the steps of:
inputting an identifying credential into a user interface to a client computer on the digital network to create a secure connection between the client computer and the server;
submitting transaction data for the negotiable instrument via the user interface to the server for approval;
placing a print request via the user interface to print the transaction instrument after approval is granted, wherein the print request initiates transfer of print data from the server to the client computer via the secure connection and wherein the print data is provided from the client computer to a printer via a second secure connection.

42. The method of claim 41 further comprising the step of monitoring the negotiable instrument via the user interface after placing the print request.

43. The method of claim 41 further comprising the step of canceling the negotiable instrument via the user interface after placing the print request.

44. The method of claim 41 wherein the print request further initiates a transfer of printer information from the printer to the server to allow retrieval of print data from the server only if the user is approved to use the printer.

45. A method of printing a negotiable instrument over a digital network, the method comprising the steps of:
contacting a server via a first secure connection on the digital network to validate a print request;
receiving a data file from the server via the first secure connection in response to the print request;
processing the data file to create a formatted file;
establishing a second secure connection to a printer;
providing the formatted file to the printer via the secure connection; and
receiving a confirmation from the printer that printing is complete.

46. The method of claim 45wherein the processing step comprises decrypting the data file.

47. The method of claim 46wherein the processing step further comprises encrypting the formatted file prior to the providing step.

48. A client system for printing a document over a digital network, the system comprising:
a first browser session configured to receive a credential from a user and to provide the credential to the server via the digital network, the browser interface having a security component configured to establish a secure connection between the browser interface and the server upon authentication of the credential by the server;
a second browser session communicating with the server via the secure connection; and
a print manager component in communication with the second browser session configured to receive a data file describing the document from the server, to process the data file to create a formatted data file, to establish a second secure connection with a printer, and to provide the formatted data file to the printer to print the document.

49. The system of claim 48 wherein the print manager component is further configured to decrypt the data file received from the server.

50. The system of claim 49 wherein the print manager component is operable to convert the data file from an XML format to a printer-executable formatted data file.

51. The system of claim 50 wherein the print manager component is further configured to encrypt the formatted data file prior to providing the formatted data file to the printer.
